(19) United States
(12) Patent Application Publication
(10) Pub. No.: US 2025/0123782 A1
(43) Pub. Date: Apr. 17, 2025

(54) PRINTING APPARATUS, METHOD OF CONTROLLING PRINTING APPARATUS, AND STORAGE MEDIUM

(71) Applicant: CANON KABUSHIKI KAISHA, Tokyo (JP)

(72) Inventor: YUKI SHIBA, Kanagawa (JP)

(21) Appl. No.: 18/914,502

(22) Filed: Oct. 14, 2024

(30) Foreign Application Priority Data
Oct. 17, 2023 (JP) 2023-178701

(51) Int. Cl. G06F 3/12

(52) U.S. Cl. CPC G06F 3/1267; G06F 3/1212; G06F 3/1251

(57) ABSTRACT

A printing apparatus performs startup processing of a first unit and a second unit that are configured to perform printing,, determines, in a case where the printing apparatus has one or more waiting print jobs, whether a first print job, from among the one or more waiting print jobs, executable using the first unit without using the second unit exists in the one or more waiting print jobs, and executes, in the case where it is determined that the first print job executable using the first unit without using the second unit exists, printing for the first print job in response to completion of the startup processing of the first unit even if the startup processing of the second unit is ongoing.

### BACKGROUND

### Field

The present disclosure relates to a printing apparatus, a method of controlling a printing apparatus, and a storage medium.

### Description of the Related Art

There are multi-layered printing media called stickers or labels, each composed of a backing and a sheet bonded to the backing. In order to achieve optimal printing on these printing media with various characteristics, there is a configuration capable of printing using color inks such as a cyan ink, a magenta ink, a yellow ink, and a black ink for image formation and using a white ink or the like for base layer formation. The inks such as the color inks and the white ink are different in necessary maintenance depending on their ink characteristics. For this reason, there is a configuration provided with a unit for the color inks and a different unit for the white ink. Since the color inks and the white ink are different in terms of necessary maintenance, one of the units may require a longer (or shorter) maintenance time than the other unit does. In this way, the maintenance operations affect a time required to make a printing apparatus ready for printing after startup by a user.

From Japanese Patent Laid-Open No. 2007-201605, there is a known technique for identifying a time for maintenance to be done after startup processing of an apparatus, beforehand in an event in which a timer for print execution is set, and executing maintenance work to make the apparatus ready for printing at a time point set in the timer.

In a case where print execution is disabled until the startup processing of units is completed, the work efficiency of a user may be decreased.

### SUMMARY

A printing apparatus according to one aspect of the present disclosure includes at least one memory storage a program and at least one processor, that when executing the program, causes the printing apparatus to perform startup processing of a first unit and a second unit that are configured to perform printing, determine, in a case where the printing apparatus has one or more waiting print jobs, whether a first print job, from among the one or more waiting print jobs, executable using the first unit without using the second unit exists in the one or more waiting print jobs, execute, in a case where it is determined that the first print job executable using the first unit without using the second unit exists, printing for the first print job in response to completion of the startup processing of the first unit even if the startup processing of the second unit is ongoing.

Further features of the present disclosure will become apparent from the following description of exemplary embodiments with reference to the attached drawings.

### BRIEF DESCRIPTION OF THE DRAWINGS

FIG. 1 illustrates a structural view of a printing apparatus.

FIG. 2 illustrates a functional block diagram of the printing apparatus.

FIG. 3 illustrates a basic flowchart of printing.

FIG. 4 illustrates a screen of a print job list.

FIG. 5 illustrates a flowchart from the start of startup to the start of printing in the printing apparatus

FIG. 6 illustrates a timeline chart from the start of startup to the start of printing in the printing apparatus.

FIG. 7 illustrates a flowchart from the start of startup to the start of printing in the printing apparatus.

FIG. 8 illustrates a timeline chart from the start of startup to the start of printing in the printing apparatus.

### DESCRIPTION OF THE EMBODIMENTS

Hereinafter, embodiments of the present disclosure will be described in detail in reference to the attached drawings. The following embodiments are not intended to limit the present disclosure according to claims. In addition, all the combinations of features described in the embodiments are not necessarily essential for the solution of the present disclosure.

### Embodiment 1

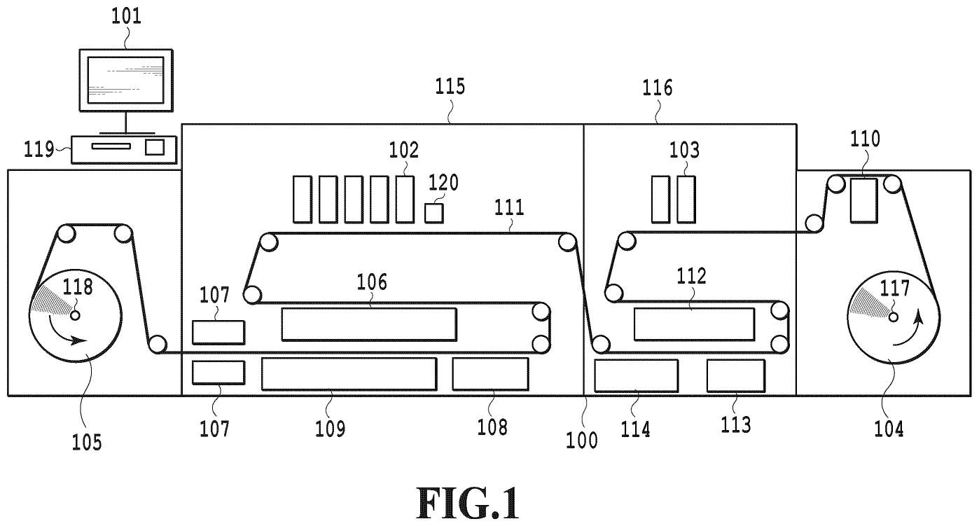

FIG. 1 illustrates an example of a schematic structure of a printing apparatus according to the present embodiment. A printing apparatus 100 is an apparatus configured to form images on a consecutively-printable, continuous printing medium (hereinafter referred to as roll paper) 111 which is used in the present embodiment. In the present embodiment, the printing apparatus 100 includes a paper feeding apparatus 104 configured to feed the roll paper 111 and a printing unit 116 configured to perform spot color printing. In addition, the printing apparatus 100 includes a printing unit 115 configured to perform basic color printing, a winding apparatus 105 configured to wind up the roll paper 111, and a user interface (hereinafter referred to as UI) operation panel 101.

The paper feeding apparatus 104 feeds the roll paper 111 to the printing apparatus 100. The paper feeding apparatus 104 rotates a paper core of the roll paper 111 around a rotation shaft 117 and thereby conveys the roll paper 111 wound around the paper core to the printing apparatus 100 at a constant speed via multiple rollers (such as conveyance rollers and paper feed rollers). The winding apparatus 105 winds up the roll paper 111 conveyed from the printing apparatus 100 around a paper core in a roll form. The paper core is attached to a rotation shaft 118. The winding apparatus 105 rotates the paper core around the rotation shaft 118 and thereby winds up the roll paper 111 as a printed product at a predetermined speed, the roll paper 111 conveyed to the paper core via multiple rollers (for example, conveyance rollers and paper delivery rollers). The printed product is wound around the paper core and stored in a roll form. Before the start of a printing operation, the roll paper 111 is fed from the paper feeding apparatus 104 to the winding apparatus 105. The roll paper 111 is set in the paper feeding apparatus 104 and the leading edge of the roll paper 111 is passed over a skew correction apparatus 110. The roll paper 111 is then passed below a printer 103 in a printing unit 116. The printer 103 in the present embodiment is an apparatus configured to print an ink of color (for example, a white ink) other than color inks of cyan (C), magenta (M), yellow (Y), and black (K). The roll paper 111 is passed below a drying apparatus 112 and above cooling apparatuses 113 and 114. Next, the roll paper 111 is passed below a mark detection sensor 120 and a printer 102 and above cooling apparatuses 108 and 109 in the printing unit 115.

In the present embodiment, alignment for forming an image by the printer 102 on an image formed by the printer 103 is performed by using, but not limited to, the mark detection sensor 120. The alignment can be performed by using a scanner apparatus. The printer 102 in the present embodiment is an apparatus configured to print the basic printing colors (CMYK). The roll paper 111 is passed through a connected scanner apparatus 107 and wound around the winding apparatus 105. After the roll paper 111 is set throughout the printing apparatus 100, a print job is submitted to a control PC (printing control apparatus) 119 in the printing apparatus 100. After the print job is submitted, a print start button is selected on the UI operation panel 101 to start the printing. The mark detection sensor 120 reads the printed image and the control PC 119 analyzes the read image to examine whether the printed product has a defect. In the present embodiment, the apparatuses necessary for the printer 103 to perform printing with the white ink in the printing unit 116, such as the printer 103, the drying apparatus 112, and the cooling apparatuses 113 and 114, are collectively referred to as a white unit. The apparatuses necessary for the printer 102 to preform printing with the color inks are collectively referred to as a color unit. Units necessary for both the white unit and the color unit to perform printing, such as the paper feeding apparatus 104 and the winding apparatus 105, are referred to as common units. In other words, on the premise that the startup processing of the common units has been completed, both printing using the color unit and printing using the white unit are performed. In the present embodiment, the printer 103 is placed in the printing unit 116 and the printer 102 is placed in the printing unit 115. In another embodiment, the printers 102 and 103 configured to print the color inks and the white ink can be arranged side by side. In this case, only one drying apparatus or cooling apparatus can be provided.

Next, a control configuration for the printing apparatus 100 will be described.

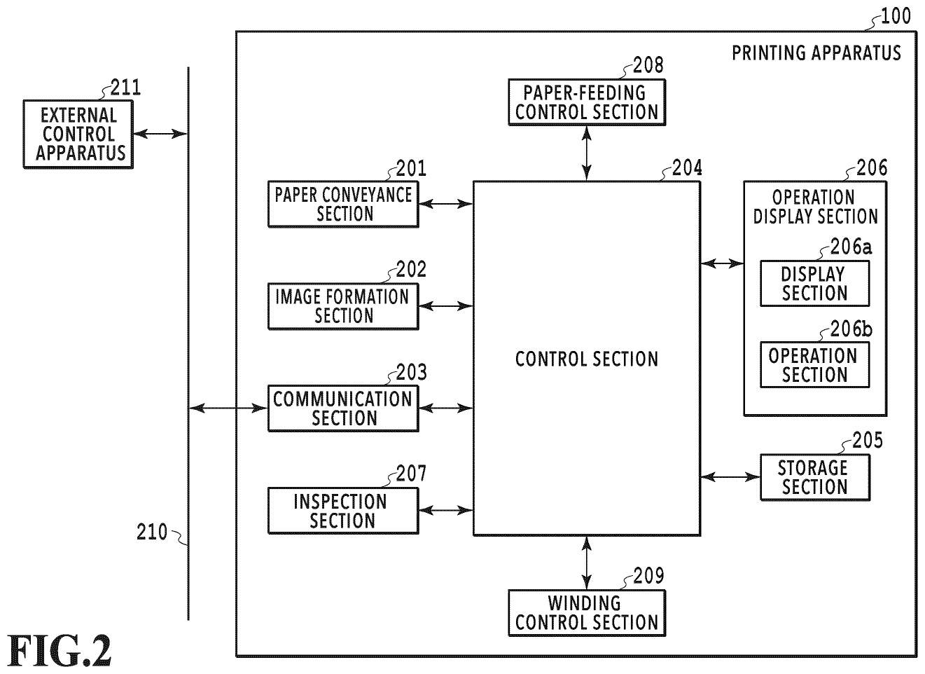

FIG. 2 illustrates a functional block diagram illustrating the control configuration for the printing apparatus 100. As illustrated in FIG. 2, the printing apparatus 100 includes a paper conveyance section 201, an image formation section 202, a communication section 203, a control section 204, a storage section 205, an operation display section 206, an inspection section 207, a paper-feeding control section 208, and a winding control section 209. The paper conveyance section 201 is a mechanism to convey the roll paper 111 inside the printing apparatus 100. For example, using multiple rollers, the paper conveyance section 201 conveys the roll paper 111 conveyed from the paper-feeding control section 208 to the image formation section 202 and conveys the roll paper 111 after passing through the image formation section 202 to the winding control section 209. The image formation section 202 forms an image on the roll paper 111 fed from the paper-feeding control section 208 based on print data for which an output instruction is received. The image formation section 202 controls both the printer 103 and the printer 102. The image formation section 202 conveys the roll paper 111 on which an image is formed to the winding apparatus 105. The communication section 203 includes, for example, a communication control card such as a local area network (LAN) card. The communication section 203 transmits and receives various kinds of data to and from an external control apparatus 211 (for example, a personal computer) connected to a communication network 210 such as a LAN or a wide area network (WAN). In the external control apparatus 211, a print application and the like necessary for printing are installed.

The control section 204 includes, for example, a central processing unit (CPU), a random access memory (RAM), etc. The CPU in the control section 204 reads various programs stored in the storage section 205 such as a system program and a processing program, expands the programs, and executes various kinds of processing according to the expanded programs. For example, the control section 204 can perform print processing to execute a print job (hereinafter simply referred to as a job) according to an instruction by a user. The storage section 205 includes, for example, a non-volatile semiconductor memory (a so-called flash memory), a hard disk drive (HDD), or the like. The storage section 205 stores the various programs including the system program and the processing program to be executed by the control section 204 and various types of data necessary for executing these programs. The operation display section 206 includes, for example, a liquid crystal display (LCD) equipped with a touch panel and includes a display section 206a and an operation section 206b.

The display section 206a displays various kinds of information on a display screen based on a display control signal input from the control section 204. The operation section 206b includes various operation keys such as ten keys and a start key, receives various input operations by the user, and outputs operation signals to the control section 204. For example, in a case of executing a job, the operation display section 206 is used to set job information or the like. The user can set, if necessary, various conditions, such as a type of paper to be used, printing speed information, the number of pages to be printed, the number of copies to be printed, a print length, and a print diameter. Timer time information set according to an instruction from the operation display section 206 is stored in the storage section 205.

The inspection section 207 is an apparatus configured to check whether printing on a printed image sheet is made without any ejection defect. The inspection section 207 causes the printing apparatus 100 to print an inspection pattern for an ejection defect inspection, reads the printed image by using a scanner to check whether the printed image has an ejection detect, and stops the printing apparatus 100 if detecting an ejection defect. As the inspection method, there are various methods that are applicable, such as a method of printing an inspection pattern and reading the printed inspection pattern with a scanner, an inspection method of directly reading a printed image with a camera or scanner, and a method of monitoring ejection states from nozzles. In the present embodiment, the inspection section 207 is configured to check whether there is an ejection defect in the method of printing the inspection pattern and reading the printed inspection pattern with the scanner. The mechanism (unit) sections included in the printing apparatus 100 are controlled by the control section 204 or the other sections.

In the present embodiment, a standby status is defined as a status where software for a system of the control section 204 or systems of the other sections is activated but hardware portions for the mechanisms in the printing apparatus 100 are powered off. In the standby status, a system control without any mechanism operation in the apparatus is enabled to operate. In the standby status, the operation display section 206 is enabled to display an apparatus status and the control section 204 is enabled to perform print processing for a job, various other settings, and the like in the same manners as in an activated status of the apparatus. The present embodiment employs two types of apparatus shutdown methods, one of which is a standby status shift in which only the mechanism sections are turned off, and the other of which is a stopped status shift in which the apparatus is completely turned off. The stopped status refers to a status in which both the hardware and the software are off and various operations are all stopped.

The control section 204 shuts down the apparatus in response to an instruction from the operation display section 206. In the standby status, if a timer start setting is made, the control section 204 uses the timer information stored in the storage section 205 to start up the mechanism sections. if no timer start setting is made, the control section 204 starts up the mechanism sections in response to a resume instruction from the operation display section 206. If the apparatus is in the stopped status, a power supply button or the like of the apparatus is selected to start up the control section 204, and the control section 204 starts up the other systems or mechanism sections. The startup of the mechanisms in the printing apparatus 100 includes maintenance processing for keeping the printing apparatus 100 under optimal conditions. In particular, the maintenance processing for keeping the quality of images printed by the printer 103 and the printer 102 includes a wide range of operations such as ink circulation and stirring and print head cleaning, and requires a considerable processing time. In the present embodiment, an example is described in which the white unit requires a longer maintenance processing time than the color unit does and accordingly requires a longer time until completion of the startup than the color unit does.

Next, description will be provided of an operation in a case where the printing apparatus 100 performs print processing on the roll paper 111. First, using an external apparatus, a user creates print data, makes print settings and a delivery number setting for a job, and transmits this information to the printing apparatus 100 via the communication network 210. The control section 204 in the printing apparatus 100 receives the data for the job and a job ticket transmitted from the external apparatus via the communication section 203, the job ticket containing the print setting information and the delivery number information for the job, and the like.

Next, a basic flow of printing in the printing apparatus will be described.

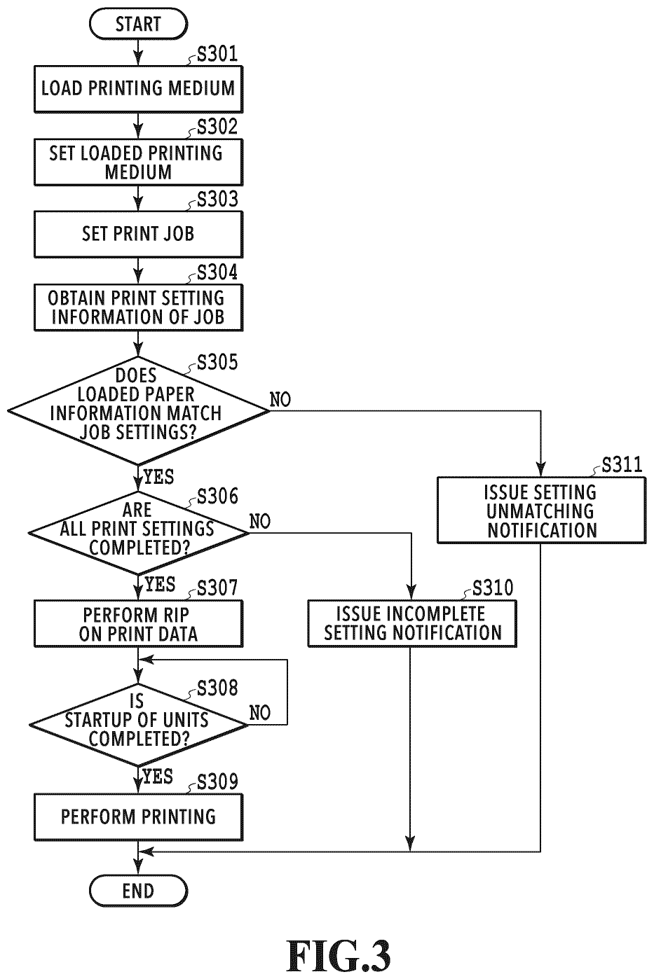

FIG. 3 illustrates a basic flowchart of printing, in reference to which a sequence from loading of a printing medium onto the apparatus to printing will be described. In the processing in this flowchart, the CPU of the control section 204 reads out the various programs such as the system program and the processing program stored in the storage section 205, expands the programs onto the RAM, and executes various processes according to the expanded programs. Sign “S” in description of each process in this flowchart indicates a step in the flowchart, and the same applies to the flowcharts described below.

First, in S301, a printing medium is loaded onto the paper feeding apparatus 104 in the printing apparatus 100. In the present embodiment, the printing medium is wound in a roll form. The printing medium wound in the roll form is drawn out, is passed along a route of a conveyance mechanism of the printing apparatus 100 via multiple conveyance rollers, and is fixed to a winding core attached to the winding apparatus 105, which is the terminal end of the conveyance route. In S302, the user sets the printing medium loaded to the printing apparatus 100 before the print processing is started. The user does this by designating one of printing media registered in advance in the printing apparatus 100. As a result, optimal conveyance parameters associated with printing medium information stored in advance are set, so that the loaded printing medium can be conveyed appropriately.

The parameters set in a print job include the conveyance parameters as well as whether to execute white printing, a masking rate in white printing, a drying temperature after white printing, a drying temperature after color printing, and a tension to be applied on the printing medium. The possible parameters also include the types of inks used, a type of a color profile to be used for color matching, etc. These print parameters are just examples, and the present embodiment is not limited to these parameters. In the printing apparatus 100, if the same printing medium as the loaded printing medium is not registered in advance, a printing medium having similar physical characteristics or features to those of the loaded printing medium is set. The physical characteristics include a raw material type of the printing medium (such as coated paper, woodfree paper, or film), a thickness, width, or basis weight of the printing medium, etc.

In S303, the user sets a print job in which print data and a medium for printing or print settings are described. The processes in S302 and S303 are executed by the user operating the control PC 119 in the printing apparatus 100. The created print job is transmitted to the printing apparatus 100. In S304, the control section 204 in the printing apparatus 100 obtains print setting information containing the print job set by the user. The control section 204 analyzes the print job contained in the print setting information.

Before the start of printing, the control section 204 determines in S305 whether the printing medium designated in the print job matches the printing medium loaded in the printing apparatus 100. If it is determined that the printing medium designated in the print job does not match the printing medium loaded in the printing apparatus 100, the processing proceeds to S311. If it is determined that the printing medium designated in the print job matches the printing medium loaded in the printing apparatus 100, the processing proceeds to S306.

In S311, the control section 204 notifies the user that printing is inexecutable due printing mediums not matching. The control section 204 then terminates the processing. In S306, the control section 204 determines whether all the print settings necessary for printing are completed. If it is determined that the print settings necessary for printing are not completed, the processing proceeds to S310. If it is determined that the print settings necessary for printing are completed, the processing proceeds to S307. In S310, the control section 204 notifies the user that the print settings are not completed. Then, the control section 204 terminates the processing.

In S307, the control section 204 performs a raster image processor (RIP) process on the print image data designated in the print job.

In the RIP process, it is possible to perform a process in which vector image data that is image data described in commands is transformed into raster image data composed of a set of print pixels. In addition, some printing apparatuses include a color conversion function to convert the colors of print data.

In S308, the control section 204 determines whether the startup of the mechanism (unit) sections in the apparatus is completed. If it is determined that the startup of the mechanism sections in the apparatus is completed, the processing proceeds to S309. The timing for checking whether the startup of the mechanism sections is completed is not limited to this timing. For example, the checking can be performed at a different timing before printing in the print control flow or before the print control flow.

In S309, the control section 204 executes printing of the RIP-processed print image data. The control section 204 then terminates the processing.

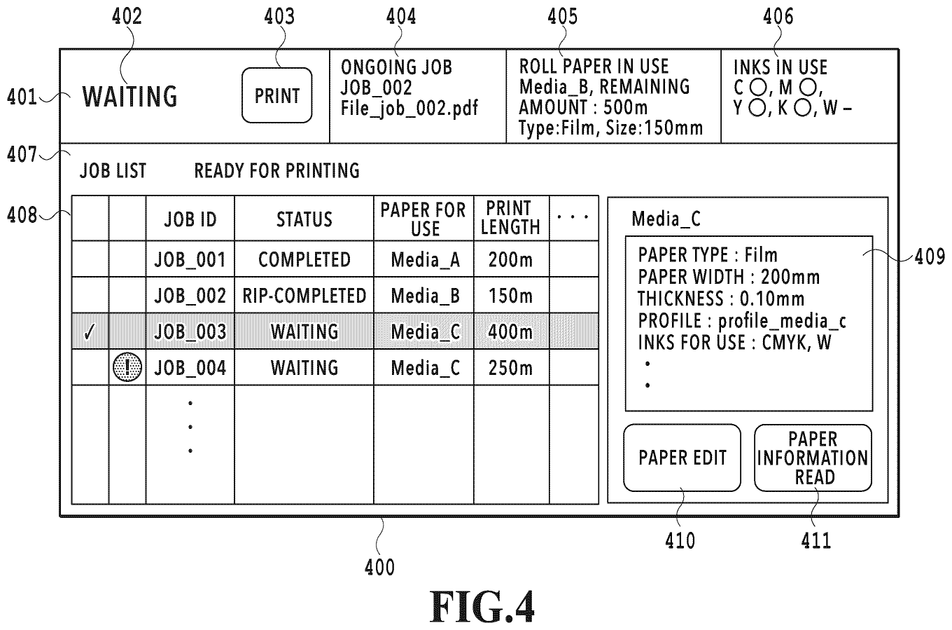

FIG. 4 illustrates an example of a UI screen displaying a list of print jobs. In FIG. 4, an entire UI screen 400 is an entire UI displayed on the UI operation panel 101. A status display area 401 displays summary information regarding the status of the printing apparatus 100, such as the current status of the printing apparatus 100 and information about a job currently being printed. An operation status display 402 of the printing apparatus 100 displays the status of the printing apparatus 100. In FIG. 4, the operation status display 402 displays “Waiting” indicating that the printing apparatus 100 is waiting for printing. In addition to “Waiting”, there are operation statuses such as “Stopped” and “Printing”. If a print button 403 is selected, printing of a selected print job is started. An ongoing job display 404 displays the name of a job currently being printed. A printing medium information display 405 displays the name, the remaining amount, etc., of the printing medium loaded to the printing apparatus 100. An ink state display 406 displays the types and the remaining amounts of the inks being used. While the present embodiment includes the above-described contents of the status display area 401, these are not seen to be limiting. The status display area 401 can display any state associated with the printing apparatus 100.

A work area 407 is a work area for the user to perform operations. In order to check detailed information about each type of the information in the status display area 401, the corresponding one of status display regions in the status display area 401 is selected and the related detailed information can be displayed in the work area 407. For example, if the ongoing job display 404 is selected, the screen is switched to a display of a list of print jobs. The screen switching method is not limited to above-described method. A menu screen can be provided and the screen can be switched in response to a selection from the menu screen. A print job list table 408 displays information on each print job such as an ID, a current status, and a printing medium. If the print button 403 is selected for a job selected from this list, the printing apparatus 100 starts printing the selected job. A printing medium detail display 409 displays detailed information on a printing medium. A sheet edit button 410 enables editing of the information on the printing medium displayed in the printing medium detail display 409. A paper information read button 411 is used to read new paper information other than the paper information currently set. The settings read using the paper information read button 411 are displayed in the printing medium information display 405 as the information on the printing medium loaded to the printing apparatus 100.

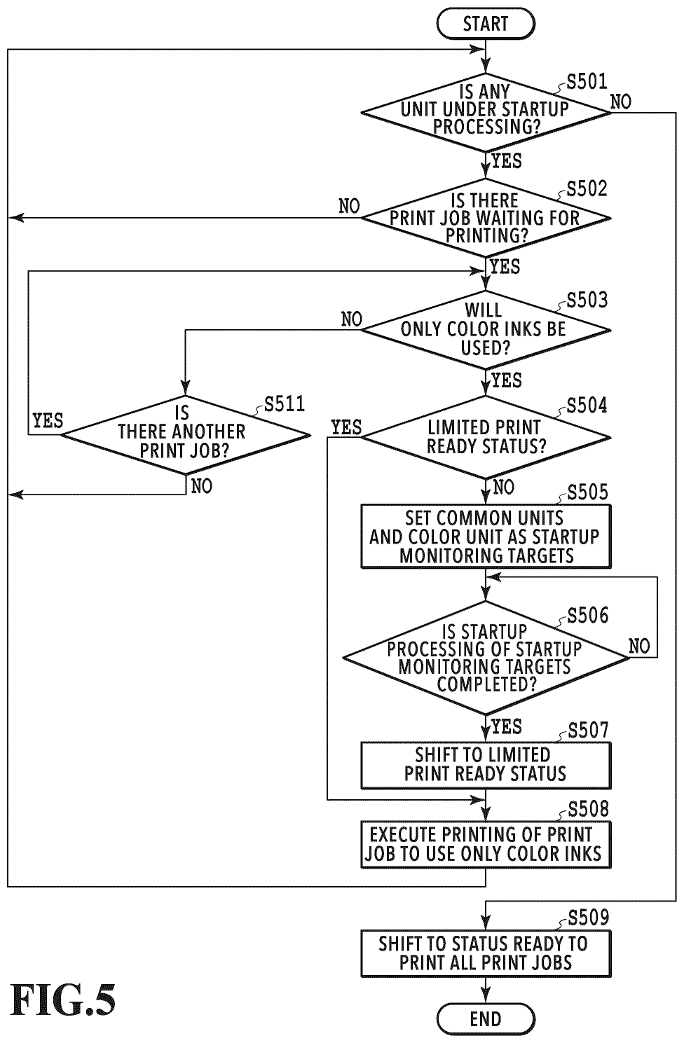

FIG. 5 illustrates a diagram illustrating a flowchart for performing print control according to the present embodiment on units to be monitored based on information in a print job after the start of the startup processing of the printing apparatus 100. As with the case of the processing in the flowchart of FIG. 3, in the processing in the present flowchart, the CPU of the control section 204 reads out the various programs such as the system program and the processing program stored in the storage section 205, expands the programs onto the RAM, and executes various processes according to the expanded programs.

The processes illustrated in FIG. 5 begin with the start of the startup processing of the mechanisms in response to a startup instruction made by the user selecting the power-on button of the printing apparatus 100 in the stopped status, a startup instruction made by the user in the standby status, or an automatic mechanism startup instruction based on the timer startup setting. In the present embodiment, the following two cases are considered in which the user submits a job to the apparatus in the standby status and in which the user submits a job during the startup processing of the mechanisms.

In S501, the control section 204 determines whether any of the units is under the startup processing. In the present embodiment, “the units” are “the common units”, “the color unit”, and “the white unit” as described above with reference to FIG. 1. If it is determined that any of the units is under the startup processing, the processing proceeds to S502. If it is determined that no units are under the startup processing, the processing proceeds to S509.

In S502, the control section 204 determines whether at least one print job is waiting. If no print job is waiting, the processing returns to S501, i.e., the startup processing continues. If the print job is waiting, the processing proceeds to S503.

In S503, regarding any of the waiting print jobs, the control section 204 determines whether only the color inks will be used. A method of confirming the inks to be used can obtaining the ink information during RIP, specifying the inks as parameters by the user at the submission of print data, obtaining the ink information by performing a preflight at the submission of the print data, or the like. If it is determined that only the color inks will be used, the processing proceeds to S504. If it is determined that ink other than the color inks will be used, the processing proceeds to S511.

In S511, the control section 204 determines whether there is another print job having yet to undergo the process of determining whether only the color inks will be used in S503. If there are other print jobs, the processing returns to S503 and the processing in step S503, as described above, is repeated for those other print jobs. In other words, in S503 and S511, whether the waiting print jobs include at least one print job that will use only the color inks is determined.

In S504, the control section 204 determines whether the printing apparatus 100 is in a limited print ready status. In the present embodiment, the limited print ready status is, for example, an only color print ready status. The only color print ready status is a status ready to execute a print job that will use only the color inks. Therefore, for example, a print job that will use the white ink is inexecutable. If it is determined in S504 that the printing apparatus 100 is in the limited print ready status, the processing proceeds to S508. If it is determined that the printing apparatus 100 is not in the limited print ready status, the processing proceeds to S505. In S505, the control section 204 sets the common units and the color units as startup monitoring targets in the printing apparatus 100. As the startup monitoring target, a unit targeted depending on a given situation to monitor whether the startup processing is completed is set.

In S506, the control section 204 receives a startup processing status of each of the startup monitoring targets from the paper-feeding control section 208, the winding control section 209, the paper conveyance section 201, or the image formation section 202, and determines whether the startup processing of the startup monitoring targets is completed. If it is determined that the startup processing is completed, the processing proceeds to S507. If it is determined that the startup processing is not completed, the processing remains in step S506 and waits until the startup processing of the startup monitoring targets is completed.

In S507, the control section 204 shifts the printing apparatus 100 to the limited print ready status. Specifically, the control section 204 shifts the printing apparatus 100 to the limited status ready to print a print job that will use only the color inks. At this time, “Waiting (Color Print Only)” is displayed on the operation status display 402 of the operation display section 206 and the print button 403 is enabled. In S508, in response to a print start operation performed by the user, the control section 204 starts printing a print job that will use only the color inks and that is printable by the units other than the white unit, which is still under the startup processing. After the printing execution is completed, the processing returns to S501. If no units are under the startup processing in S501 (in other words, the startup of all the units is completed), the processing proceeds to S509. The units under the startup processing in S501 refer to all the units regardless of whether a unit is set as the startup monitoring target. In the present embodiment, the units under the startup processing in S501 refer to the color unit, the white unit, and the common units.

In S509, the control section 204 shifts the printing apparatus 100 to a status ready to print all print jobs. At this time, the operation status display 402 of the operation display section 206 displays “Waiting”, which indicates that the printing apparatus 100 is ready to receive all types of printable data. After the completion of the process in S509, the control section 204 terminates the processing.

In the present embodiment, the print button 403 is enabled after the printing apparatus 100 becomes ready for printing. However, the present embodiment is not limited to implementation. For example, the print button 403 can be selected in advance and then the printing can automatically start upon completion of the RIP process on image data or upon transmission of the RIP-processed data from the external control apparatus 211. The present embodiment discusses an example in which there are two print units, the color unit and the white unit, but this configuration is not seen to be limiting. For example, in another embodiment, another spot color unit can be added, and accordingly, another limited print ready status can be added. In yet another embodiment, only the white unit can be monitored, and printing that will use only the white ink in the first place enabled.

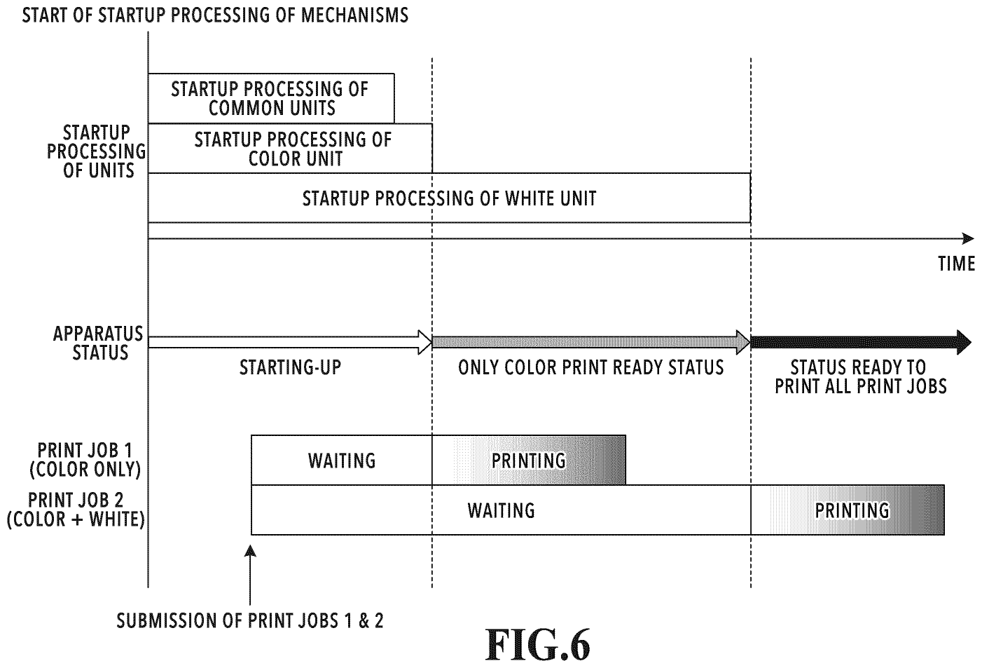

FIG. 6 illustrates a timeline chart of the startup processing of the units, the status of the printing apparatus 100, and the printing statuses of submitted print jobs. A print job 1 is a print job that will use only the color inks. A print job 2 is a print job that will use the color inks and the white ink. Since printing is disabled while the common units and the color unit are under the startup processing, the printing apparatus 100 is in a “starting-up” status and both the print jobs 1 and 2 are in a “waiting” status. Upon completion of the startup processing of the common units and the color unit, the printing apparatus 100 shifts to the limited status ready for only color printing and starts printing the print job 1. Since the print job 2 is the print job that will use the white ink, it remains waiting without execution of printing.

Upon completion of the startup processing of the white unit, the printing apparatus 100 shifts to the status ready to print all print jobs and starts printing the print job 2. Thus, if a print job that will use only the color inks is waiting during the startup processing, the printing apparatus 100 first shifts to the only color print ready status (the limited print ready status) in response to completion of the startup processing of the color unit and common units. Then, upon completion of the startup processing of the white unit, the printing apparatus 100 shits to the status ready to print all print jobs. This is because the startup processing of the white unit requires a longer time than the startup processing of the color unit. Therefore, for example, even if the print job 2, from the print job 1 and the print job 2, is submitted before the print job 1, the printing apparatus 100 first prints the print job 1 that will use only the common units and the color unit whose startup processing is completed first. While the present embodiment is described such that the startup processing time of the color unit is shorter than that of the white unit, if the startup processing time of the color unit is actually longer than that of the white unit, the process can be reversed.

If the print job 1 and the print job 2 are desired to be printed consecutively, a function to turn off the function to shift to the limited print ready status can be provided to the printing apparatus 100, job settings, or the like. The print job 1 and the print job 2 can be printed consecutively by predicting the printing time for the print job 1 and the startup processing time of the white unit and starting printing the print job 1 with the time obtained by subtracting the printing time for the print job 1 from the time of the startup completion of the white unit taken into consideration.

In the case of a structure in which the roll paper 111 first passes through the printing (white) unit 116 and then passes through the printing (color) unit 115, as in FIG. 1, in printing in the limited print ready status, the startup processing without affecting the ongoing printing is performed on the unit under the startup processing. Specifically, for example, operations in the startup processing that may not affect the printing using the color unit are performed on the white unit under the startup processing. For example, the operations in the startup processing that may not affect the printing include a temperature adjustment of the cooling apparatuses, an ink filling process, an ink circulation process, a buzzer check, and the like. Operations in the startup processing that may affect the printing can be performed while printing is not performed (before or after the printing).

As described above, according to the present embodiment, the work efficiency during the startup processing of the apparatus can be improved. Specifically, in the case where the printing apparatus 100 includes a first (color) unit requiring a short startup processing time and a second (white) unit requiring a long startup processing time, the printing apparatus 100 executes printing for a print job printable by the first unit upon completion of the startup processing of the first unit. In this way, the printing can be executed without waiting for completion of the startup processing of the second unit, so that the work efficiency can be improved.

### Embodiment 2

In another embodiment, description will be provided of processing in a case where no print job is submitted at a start time of the startup processing of the printing apparatus 100.

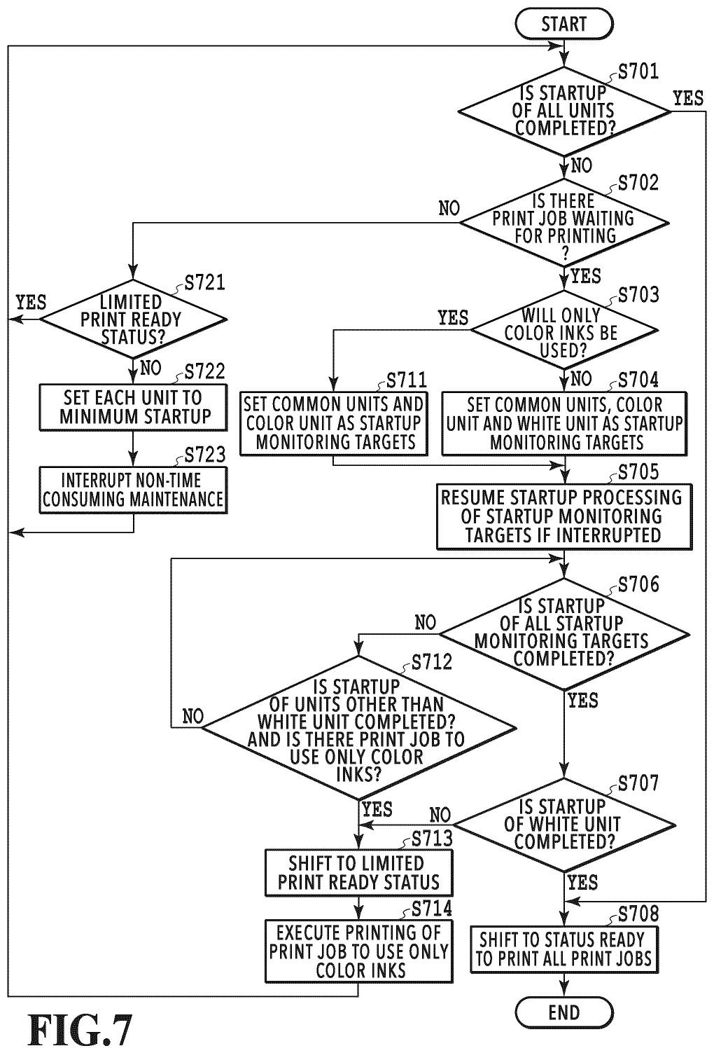

FIG. 7 illustrates a diagram illustrating a flowchart of startup processing of the mechanisms in the printing apparatus 100 in the present embodiment. As with the case of the processing in the flowchart of FIG. 3, in the processing in the present flowchart, the CPU of the control section 204 reads out the various programs such as the system program and the processing program stored in the storage section 205, expands the programs onto the RAM, and executes various processes according to the expanded programs.

The processing is started in response to a startup instruction made by the user selecting the power-on button of the printing apparatus 100 in the stopped status, a startup instruction made by the user in the standby status, or an automatic mechanism startup instruction according to the timer startup setting. The processing in the present embodiment supports a case where a user submits a print job to the printing apparatus 100 in the standby status and a case where the user submits a print job during the startup processing of the mechanisms.

In S701, the control section 204 determines whether the startup of all the units is completed. If it is determined that the startup of all the units is completed, the processing proceeds to S708. If it is determined that the startup of all the units is not completed, the processing proceeds to S702.

In S702, the control section 204 determines whether at least one print job is waiting. If it is determined that the print job is waiting, the processing proceeds to 703. If it is determined that no print job is waiting, the processing proceeds to 721.

In S721, the control section 204 determines whether the printing apparatus 100 is in the limited print ready status. If the printing apparatus 100 is in the limited print ready status, the processing returns to S701. If the printing apparatus 100 is not in the limited print ready status, the processing proceeds to S722. In S722, the control section 204 sets the startup of each of the units to minimum startup. In the present embodiment, the minimum startup is, for example, performing time-consuming maintenance items while not performing particular non-time consuming maintenance items (for example, drying process, buzzer check, and the like). Next, in S723, in response to an instruction from the control section 204, each of the units interrupts the non-time consuming maintenance items and performs the time-consuming maintenance items (for example, processes such as ink circulation, ink temperature adjustment, and ink filling). In S723, instead of the interruption, a mechanism section requiring only a short startup time can be stopped from starting up from the beginning.

Returning to S702, as discussed above, if it is determined that the print job is waiting, the processing proceeds to 703. In S703, the control section 204 determines whether all the waiting print jobs are print jobs that will use only the color inks. A method of confirming the inks to be used can be obtaining the ink information during RIP, specifying the inks as parameters by the user at the submission of print data, obtaining the ink information by performing a preflight at the submission of the print data, or the like. If it is determined that all the waiting print jobs will use only the color inks, the processing proceeds to S711. If it is determined that all the waiting print jobs include at least one print job that will use the white ink, the processing proceeds to S704.

In S704, the control section 204 sets the common units, the color unit, and the white unit as the startup monitoring targets. In S711, the control section 204 sets the common units and the color unit as the startup monitoring targets. Then, in S705, the control section 204 resumes the startup processing of the units set as the startup monitoring targets if the startup processing is interrupted. This process is executed in response to a notification issued by the control section 204 to each of the sections that perform the respective mechanism processes that are illustrated in FIG. 2.

In S706, the control section 204 determines whether the startup of all the startup monitoring targets is completed. If it is determined that the startup of all the startup monitoring targets is not completed, the processing proceeds to S712. If it is determined that the startup of all the startup monitoring targets is completed, the processing proceeds to S707.

In S712 it is determined whether the startup of the common units and the color unit is completed and whether there is a print job that will use only the color inks. If it is determined that the startup of the common units and the color unit is completed and there is the print job that will use only the color inks, the processing proceeds to S713. If it is determined that the startup of the common units and the color unit is not completed or that there is no print job that will use only the color inks even though the startup of the common units and the color unit is completed, the processing returns to S706.

In S707 it is determined whether the startup of the white unit is completed. If it is determined that the startup of the white unit is not completed, the processing proceeds to S713. If it is determined that the startup of the white unit is completed, the processing proceeds to S708.

In S713, the control section 204 shifts the printing apparatus 100 to the limited print ready status in which printing with only the color inks is ready. At this time, the operation status display 402 of the operation display section 206 displays “Waiting (Color Print Only)” and the print button 403 is enabled. Then, in S714, the control section 204 executes printing for a print job that will use only the color inks. The processing then returns to S701.

If the startup of the white unit is completed in S707 or if the startup of all the units is completed in S701, the control section 204 shifts the printing apparatus 100 to the status ready to print all print jobs in S708. At this time, the operation status display 402 of the operation display section 206 displays “Waiting”, which indicates that the printing apparatus 100 is ready to receive all types of printable data. Upon completion of S708, the control section 204 terminates the processing.

The startup processing in the present embodiment is as described above. If no print job is waiting at the start of the startup processing of the units, the control section 204 sets all the units to the minimum startup in S722. As a result, the non-time consuming maintenance is interrupted (or are not started from the beginning), so that the costs for electric power, etc., can be reduced. Then, the interrupted maintenance is resumed in sequence in response to a print job. This enables reducing the startup time in resuming. For example, if a job that will use only the color unit without using the white unit is submitted, the interrupted processing of the white unit is left interrupted and only the startup of the common units and the color unit is resumed. This results in a reduction in the costs because the maintenance of the white unit is not performed. In addition, since the interrupted maintenance of the common units and the color unit is resumed, it is possible to shorten the startup time compared with the case where the startup processing is performed from the beginning.

In the case where a print job is already submitted by the start time of the startup processing, the processes of interrupting the maintenance, etc., are not performed and printing is performed upon completion of the startup processing of the units necessary to execute the submitted print job as in the above-described Embodiment 1.

In the present embodiment, the print button 403 is enabled after the printing apparatus 100 enters the print ready status. However, the present embodiment is not limited to this. For example, the print button 403 can be selected in advance and then the printing can automatically be started upon completion of the RIP process on the image data or upon transmission of the RIP-processed data from the external control apparatus 211. The present embodiment discusses an example in which there are two print units, the color unit and the white unit, but this is not seen to be limiting. For example, in another embodiment, another spot color unit different in the maintenance processing, etc., can be added and another limited print ready status can also be added. In addition, only monitoring the white unit and enabling printing that will use only the white ink in the first place can be implemented.

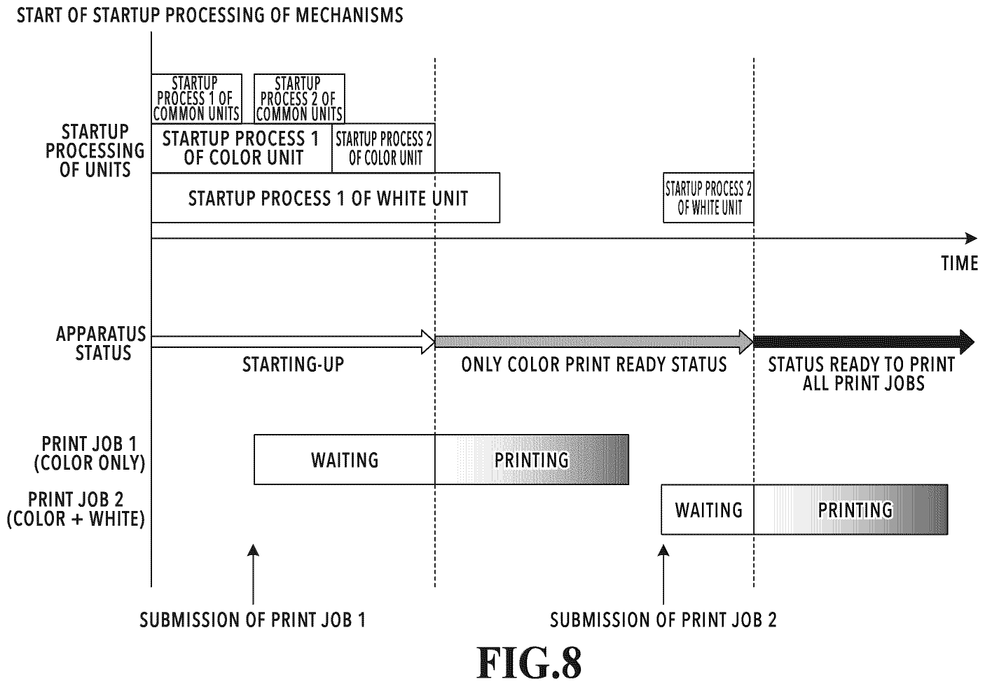

FIG. 8 illustrates a timeline chart of the startup processing of the units, the status of the printing apparatus 100, and the printing statuses of submitted print jobs 1 and 2.

Since printing of any print job is disabled while the common units and the color unit are under the startup processing, the printing apparatus 100 is in a “starting-up” status and both the print jobs 1 and 2 are in a “waiting” status. In the present embodiment, each of the units involves a startup process 1 and a startup process 2. The startup process 1 is a startup process including maintenance items each requiring a long execution time (for example, such as ink circulation, ink temperature adjustment, and ink filling), while the startup process 2 is a startup process including maintenance items each requiring a short execution time (for example, such as drying process and buzzer check). The ratio of the startup process 1 to the startup process 2 varies depending on the specific structure of the apparatus in question. If the execution time for each maintenance item is short, the ratio of the startup process 1 to the startup process 2 can be 0:100.

The common units perform the startup process 1 and then suspend the startup process 2 because no print job is submitted. The common units perform the startup process 2 after a print job that will use the color inks is submitted.

Since the startup process 1 is being executed when the print job 1 is submitted, the color unit performs the startup process 2 upon completion of the startup process 1. Upon completion of the startup processing of the common units and the color unit, the printing apparatus 100 shifts to the limited status ready for only color printing, and starts printing the print job 1 that will use only the color inks.

Since no print job that will use the white ink is submitted, the white unit completes only the startup process 1 and then suspends the startup process 2. At the timing of the submission of the print job 2, the white unit performs the suspended startup process 2. Since the time-consuming startup process 1 of the white unit is already completed by the time of the submission of the print job 2 that will use the white ink, the printing apparatus 100 prints the print job 2 as soon as the startup process 2 is completed. Then, the printing apparatus 100 shifts to the status ready to print all print jobs.

As described above, according to the present embodiment, the maintenance operations of each of the units are changed based on a submitted print job. Thus, for example, if print jobs include no print job that will use the first unit, some of the maintenance items of the first unit are suspended. This enables reducing the costs for electric power, etc. The suspended maintenance items are resumed upon submission of a print job that will use the first unit. Thus, the startup time can be shortened as compared with the case where the entire startup processing of the first unit is not performed at all.

While the non-time consuming startup process is described as an example of the maintenance items to be suspended, this is not seen to be limiting. For example, a maintenance operation that will not affect ongoing printing can be performed in response to submission of a print job that will use the corresponding unit. A maintenance operation that will affect ongoing printing can be performed at initial startup or after the ongoing printing is finished.

In the case, for example, where some of the maintenance items of the white unit are to be suspended, maintenance items that will not affect printing for a print job by using the color unit and the common units can be suspended. Then, the suspended maintenance items can be resumed in response to submission of a print job that will use the white unit.

### Other Embodiments

While the foregoing embodiments are described such that the startup processing of the white unit requires a longer time than the startup processing of the color unit does, this is not seen to be limiting. In another embodiment, there can be a case where the startup processing of the white unit requires a shorter time. Specifically, in a case where a printing apparatus includes a first (white) unit that requires a short startup processing time, and a second (color) unit that requires a long startup processing time, the printing apparatus executes printing for a print job printable by the first unit upon completion of the startup processing of the first unit. Thus, the printing can be executed without waiting for completion of the startup processing of the second unit, which results in improvement in work efficiency.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-178701, filed Oct. 17, 2023, which is hereby incorporated by reference wherein in its entirety.

What is claimed is:

1. A printing apparatus comprising:
at least one memory storing a program; and
at least one processor, that when executing the program, causes the printing apparatus to:
perform startup processing of a first unit and a second unit that are configured to perform printing;
determine, in a case where the printing apparatus has one or more waiting print jobs, whether a first print job, from among the one or more waiting print jobs, executable using the first unit without using the second unit exists in the one or more waiting print jobs; and
execute, in a case where it is determined that the first print job executable using the first unit without using the second unit exists, printing for the first print job in response to completion of the startup processing of the first unit even if the startup processing of the second unit is ongoing.

2. The printing apparatus according to claim 1, wherein
the processor is further configured to cause the printing apparatus to execute, in a case where it is determined that a second print job to be executed using the second unit is waiting, printing for the second print job in response to completion of the startup processing of the second unit.

3. The printing apparatus according to claim 2, further comprising a third unit, wherein
the processor is further configured to cause the printing apparatus to execute the first print job or the second print job based on startup processing of the third unit is completed.

4. The printing apparatus according to claim 3, wherein the third unit controls a paper feeding apparatus or a winding apparatus.

5. The printing apparatus according to claim 1, wherein a timing associated with the determining is at a start time of the startup processing or during the startup processing.

6. The printing apparatus according to claim 1, wherein the first unit controls printing using a color ink.

7. The printing apparatus according to claim 1, wherein the second unit controls printing using a white ink.

8. The printing apparatus according to claim 1, wherein
the processor is further configured to cause the printing apparatus to interrupt, in a case where the printing apparatus does not have a waiting print job while the startup processing is performed, a certain maintenance operation included in the startup processing in both the first unit and the second unit.

9. The printing apparatus according to claim 8, wherein the certain maintenance operation includes a drying process or a buzzer check process.

10. The printing apparatus according to claim 8, wherein the certain maintenance operation is performed after a print job that uses a targeted unit is submitted.

11. The printing apparatus according to claim 1, wherein
the processor is further configured to cause the printing apparatus to not execute,
in a case where the printing apparatus does not have a waiting print job at the start of the startup processing, a certain maintenance operation in both the first unit and the second unit.

12. A method of controlling a printing apparatus, comprising:
performing startup processing of a first unit and a second unit that are configured to perform printing;
determining, in a case where the printing apparatus has one or more waiting print jobs, whether a first print job, from among the one or more waiting print jobs, executable using the first unit without using the second unit exists in the one or more waiting print jobs; and
executing, in the case where it is determined that the first print job executable using the first unit without using the second unit exists, printing for the first print job in response to completion of the startup processing of the first unit even if the startup processing of the second unit is ongoing.

13. The control method according to claim 12, further comprising executing, in a case where it is determined that a second print job to be executed using the second unit is waiting, printing for the second print job in response to completion of the startup processing of the second unit.

14. The control method according to claim 12, wherein a timing associated with the determining is at a start time of the startup processing or during the startup processing.

15. The control method according to claim 12, further comprising interrupting, in a case where the printing apparatus does not have a waiting print job while the startup processing is performed, a certain maintenance operation included in the startup processing in both the first unit and the second unit.

16. The control method according to claim 15, wherein the certain maintenance operation includes a drying process or a buzzer check process.

17. The control method according to claim 15, wherein the certain maintenance operation is performed after a print job that uses a targeted unit is submitted.

18. The control method according to claim 12, wherein
in a case where the printing apparatus does not have a waiting print job at the start of the startup processing, a certain maintenance operation in both the first unit and the second unit is not executed.

19. A non-transitory computer readable storage medium storing a program for executing a method for a printing apparatus, the method comprising:
performing startup processing of a first unit and a second unit that are configured to perform printing;
determining, in a case where the printing apparatus has one or more waiting print jobs, whether a first print job, from among the one or more waiting print jobs, executable using the first unit without using the second unit exists in the one or more waiting print jobs; and
executing, in the case where it is determined that the first print job executable using the first unit without using the second unit exists, printing for the first print job in response to completion of the startup processing of the first unit even if the startup processing of the second unit is ongoing.
